(19) United States
(12) Patent Application Publication
(10) Pub. No.: US 2026/0022705 A1
(43) Pub. Date: Jan. 22, 2026

(54) ROTATION DEVICE AND METHOD FOR DETERMINATION OF A CONDITION OF A BEARING ARRANGEMENT

(71) Applicant: ebm-papst Mulfingen GmbH & Co. KG, Mulfingen (DE)

(72) Inventors: Sebastian Schroth, Kupferzell (DE); Markus Borck, Assamstadt (DE)

(21) Appl. No.: 19/274,888

(22) Filed: Jul. 21, 2025

(30) Foreign Application Priority Data
Jul. 19, 2024 (DE) 10 2024 120 523.7

(51) Int. Cl. F04D 27/00; F04D 25/06; F16C 41/00; H02P 29/032

(52) U.S. Cl. CPC F04D 27/001; F04D 25/06; F16C 41/00; H02P 29/032; F16C 2233/00; F16C 2360/46

(57) ABSTRACT

The present disclosure refers to a rotation device, particularly a flow producing device, as well as methods that are configured to determine a condition of a bearing arrangement of rotation device. The bearing arrangement bears a rotor of an electric motor and/or a rotor arrangement including the rotor rotatingly around a rotating axis. At least one rotation parameter is determined that describes the rotation around the rotation axis, as well as at least one power parameter that describes the power of the electric motor. The determination of the at least one rotation parameter and the at least one power parameter is carried out to a current observation point in time, particularly at least at one observation point in time during a determination time phase. The at least one rotation parameter and the at least one power parameter are evaluated in relation to one another and therefrom a condition parameter is determined describing the condition of bearing arrangement. Particularly for this purpose a linear component of a power-rotation-correlation between the at least one current rotation parameter and the at least one current power parameter is used.

### CROSS REFERENCE TO RELATED APPLICATIONS

This application claims priority under 35 U.S.C. § 119 to the following German Patent Application No. 10 2024 120 523.7, filed on Jul. 19, 2024 the entire contents of which are incorporated herein by reference thereto.

### BACKGROUND

The present disclosure refers to a rotation device as well as a method for determination of a condition of a bearing arrangement of the rotation device. The rotation device has a stator arrangement and a rotor arrangement that is rotatingly supported around a rotation axis relative to the stator arrangement. The rotation device has an electric motor having a stator that is part of the stator arrangement, as well as a rotor that is part of the rotor arrangement. The rotor arrangement can have rotating bodies attached to the rotor of the electric motor or drivingly coupled with the rotor of the electric motor, wherein the rotating bodies can be rotatingly driven around the rotation axis. For example, the rotating bodies are configured to produce a fluid flow when the rotor arrangement is rotatingly driven. Thus, the rotating bodies can comprise blades of a flow producing device, for example. The flow producing device can be, for example, a fan for producing a gas flow, particularly air flow, or a pump for producing a fluid flow.

DE 10 2009 034 369 B3 discloses a control of a fan. The control has the object to achieve a desired fan rotational speed. Due to voltage deviations and aging effects, a deviation from the desired rotational speed may result. By means of an aging test, an aging factor can be determined that describes a rotational speed change depending on the age of the fan. In addition, a characteristic curve can be determined describing the dependency between the voltage deviation at the fan motor and a rotational speed change. Based on the aging factor and the measured voltage deviation, an improved rotational speed control can be achieved.

EP 2 174 097 B1 discloses a rotation sensor with monitoring of bearing wear. The rotation sensor creates a measurement signal describing the angular position and/or angular speed. It comprises a counter in which the wear condition is stored. Particularly, a total number of rotations can be stored that describes the aging of the rotation sensor in this manner.

Thus, the prior art mentioned above considers an increasing aging of the bearing in a rotation device, wherein the influence of the aging on the rotation condition can be determined, for example by means of tests. It is disadvantageous that influences that are not considered during the aging tests cannot be recognized. The bearing condition is estimated with increasing operation duration of the rotation device.

A drive and a method for fine tuning of the drive are described in DE 10 2020 114 222 A1. By means of a microphone the noise of the drive is determined and analyzed. The recorded noise is compared to a known, stored noise signal in order to optimize a setting of the drive.

### BRIEF SUMMARY

Starting from the prior art it can be considered as object of the present disclosure to provide a rotation device and a method that allows the determination of a current condition of a bearing arrangement of the rotation device in simple manner.

This object is solved by means of a rotation device having the features of claim 1 as well as a method having the features of claim 14.

The rotation device comprises an electric motor having a stator and a rotor. The rotor is part of a rotor arrangement. The rotor arrangement is rotatingly supported around a rotation axis by means of a bearing arrangement. The rotor arrangement has rotating bodies that are drivingly coupled with the rotor or attached on the rotor. For example, the rotating bodies can be blades of a fan or an impeller that are rotatingly supported around the rotation axis. The rotating bodies can also be vanes of a pump. Thus, the rotation device can be a flow producing device. By means of the flow producing device, a fluid flow (gas or liquid flow) can be produced.

The rotation device comprises a determination device. The determination device is configured to determine a current rotation parameter that characterizes the current rotation movement of the rotor arrangement around the rotation axis. The rotation parameter can directly or indirectly indicate the rotational speed and/or the angular speed of the rotor arrangement around the rotation axis, for example. As rotation parameter the determination device can determine one of the parameters indicated in the following or multiple of the parameters indicated in the following in arbitrary combination:
a rotational speed of the rotor arrangement,
an angular speed of the rotor arrangement,
an electromagnetic force and/or a voltage in a stator winding of the stator of the electric motor induced due to the rotation movement of the rotor of the electric motor,
a magnetic field parameter, for example the frequency or rotating speed of the stator magnetic field around the rotation axis, describing the temporal and/or spatial change of a stator magnetic field of the stator of the electric motor (for example revolution movement around the rotation axis),
a motor control parameter used for rotation control of the rotor of the electric motor.

The determination device is further configured to determine at least one power parameter characterizing the current electrical and/or mechanical power of the electric motor. One of the parameters indicated in the following or multiple of the parameters indicated in the following in arbitrary combination can be determined as current power parameter:
a motor voltage of the electric motor,
a motor current of the electric motor,
an electric power of the electric motor,
a rotation torque of the electric motor,
a motor control parameter used for power control of the electric motor, for example a duty cycle of an electric parameter, such as motor current, used for setting the electrical power.

The at least one current rotation parameter and/or the at least one current power parameter can be measured by means of a sensor directly or can be determined based on one or more sensor values by means of calculation and/or can be determined by means of simulation and/or by means of an observer. Additionally or alternatively, the at least one power parameter and/or the at least one rotation parameter can be determined based on a motor control parameter used for control of the electric motor.

The rotation device further comprises an evaluation device. The evaluation device is configured to evaluate the at least one rotation parameter and the at least one power parameter, determined by the determination device, in relation to one another. Thereby, particularly a current power-rotation-correlation is determined, for example an equation, a characteristic curve, a correlation table, a correlation function or any other mathematical relation describing the current power-rotation-correlation. In the context of the determination of the power-rotation-correlation the at least one rotation parameter and/or the at least one power parameter is particularly processed by means of a mathematical and/or analytical method in order to obtain the power-rotation-correlation therefrom. Thereby, any known approximation method (for example polynomial fitting), Fourier analysis (particularly FFT), methods of machine learning and/or methods using artificial intelligence (AI) can be used.

Particularly during determination of the power-rotation-correlation a temporal change of the power of the electric motor at a known rotation of the rotor arrangement and/or a temporal change of the rotation of the rotor arrangement at a known power of the electric motor is used. The determination of the power-rotation-correlation can be considered as pre-processing step for the further evaluation.

The at least one rotation parameter characterizes the current rotation of the rotor arrangement and the at least one power parameter describes the current power of the electric motor, for example the electrical power. The expression “current” means in this context a current point in time or a determination time phase including the current point in time during which the at least one current rotation parameter and the at least one current power parameter are determined in time-continuous manner or in time-discrete manner at multiple determination points in time. The determination time phase can be some microseconds or also some minutes. Particularly, the determination time phase is shorter than 30 minutes, shorter than 15 minutes or preferably shorter than 5 minutes. However, the determination time phase is temporarily limited, so that within the determination time phase no remarkable wear or aging effects of the rotation device occur.

For example, by means of the determination device and the evaluation device, a temporal change of the rotation of the rotor arrangement and/or a temporal change of the power of the electric motor can be detected and evaluated. The rotation depends on the power of the electric motor, so that based thereon it can be determined how the condition of the bearing arrangement is. The worse the condition of the bearing arrangement, the higher the power of the electric motor required for achieving a predetermined rotation (for example rotational speed or angular speed) of the rotor arrangement. Thus, based thereon the condition of the bearing arrangement can be determined. For example, the condition of the bearing arrangement can be transmitted to an operation interface of a system or a machine comprising the rotation device or also to an external device (for example server or cloud). Based thereon measures can be initiated, as necessary a service or a repair or an exchange of the bearing arrangement.

A power-rotation-correlation determined based on the at least one rotation parameter and the at least one power parameter can particularly comprise non-constant and non-linear components, for example components of the second degree (quadratic components) or higher, which describe the relation between the rotation and the power. The power-rotation-correlation can describe a mathematical function, for example a polynomial of at least second degree, that indicates the power depending on linear and non-linear components of the rotation, for example:

$$P = {k}_{0} + {k}_{1} \cdot D + {k}_{2} \cdot {D}^{2} + … + {k}_{n} \cdot {D}^{n} \qquad ( 1 )$$

wherein P is the power parameter, D is the rotation parameter and kᵢ are coefficients with i=0, 1, 2, . . . , n. The coefficients kᵢ can be determined in the context of the evaluation, for example by means of calculation, an estimation, a simulation, an observer, an approximation or other statistical or mathematical methods. Thereby n measurements can be carried out, that means, for example at n different rotational speeds, in order to be able to determine n coefficients kᵢ. If more measurements are provided than coefficients kᵢ to be determined, a regression function can be used in order to determine the coefficients kᵢ.

The current power-rotation-correlation particularly also indicates a linear relation between the rotation of the rotor arrangement and the power of the electric motor that is exclusively used or used in combination with other parameters for determination of the condition of the bearing arrangement in a preferred embodiment (for example linear component of the polynomial of degree n=2 or n>2). For example, a linear coefficient k₁ of the linear component of the power-rotation-correlation can be compared with at least one reference value and therefrom the condition of the bearing device can be determined. In the simplest case, one single reference value can be used as threshold for distinction of a functional bearing arrangement and a bearing arrangement with need for service or repair. As an option also multiple reference values can be used for forming different evaluation steps of the bearing arrangement. The at least one reference value can also depend on a parameter provided in form of a reference table, a reference characteristic curve or a reference characteristic diagram, etc.

Particularly, in such a power-rotation-correlation comprising non-linear components that are independent from the at least one rotation parameter as well as quadratic components in which the at least one power parameter depends on the square of the at least one rotation parameter—as well as optionally comprised components of higher degree (n≥3)—can remain unconsidered when determining the bearing condition. The quadratic components particularly describe the dependency of the current operating condition from the created flow. Constant components independent from the at least one rotation parameter are also irrelevant for the evaluation of the bearing condition and can remain unconsidered.

In an embodiment, the power consumption of the electric motor at a predefined rotation is determined based on the at least one power parameter and is evaluated. The rotation of the rotor arrangement can thereby be a constant rotation. Based on the power of the electric motor required for maintaining the rotation the condition of the bearing arrangement can be concluded.

Additionally or alternatively, at a predefined power consumption of the electric motor the rotation of the rotor arrangement can be determined based on the at least one rotation parameter and can be evaluated. For example, thereby the power provided to the electric motor can be constant. In an embodiment the power provided to the electric motor can be reduced starting from a current operating condition, for example down to zero, and the change of the rotation resulting therefrom can be determined and evaluated. The rotation change thereby depends on the bearing condition so that it can be determined based on the rotation change.

In another embodiment a duration can be determined and evaluated that is required to achieve a preset rotation change of the rotor arrangement, particularly rotational speed change, at a preset power of the electric motor. Thereby the rotation movement can be changed between two preset rotational speed conditions. The rotational speed can thereby be increased or decreased.

Generally speaking the rotation device can determine and evaluate the rotation of the rotor arrangement based on the at least one rotation parameter resulting from a known, particularly predefined power consumption of the electric motor, or can alternatively determine and evaluate the required power of the electric motor based on the at least one power parameter at a known, particularly predefined rotation of the rotor arrangement. With both alternatives, the condition of the bearing arrangement can be determined.

The rotation device can comprise a motor control that is connected to the electric motor for open-loop and/or closed-loop control, particularly by means of an electrical connection. Preferably, the motor control is electrically connected to the stator windings of the stator of the electric motor, particularly in order to create a stator magnetic field that spatially varies around the rotation axis, so-to-speak circulating stator magnetic field or stator rotation field.

Preferably the motor control is configured so that the rotation of the electric motor, particularly the rotational speed of the electric motor, is closed-loop controlled during normal operation of the rotation device. In a test operation, during the determination time phase for determination of the at least one current rotation parameter and the at least one current power parameter, as an option, the rotational speed closed-loop control can be temporarily deactivated, for example in order to preset the power consumption of the electric motor.

The electric motor can be a brushless direct current motor (BLDC), for example.

The motor control and the evaluation device can be configured as common computing device or as separate units that are communicatively connected. The determination device can comprise a computing unit as an option, if at least one parameter shall be determined by means of calculation. In this case at least the part of the determination device configured as computing unit can be part of the motor control and/or the evaluation device or can be communicatively connected with the motor control and/or the evaluation device. The determination device can have one or more sensors that are communicatively connected directly or indirectly with the motor control and/or the evaluation device.

In addition to the at least one rotation parameter and the at least one power parameter the determination device can determine any of the additional parameters indicated in the following or multiple of the parameters indicated in the following in arbitrary combination:
a vibration parameter that describes a vibration at a non-rotatingly supported component of the rotation device,
a noise parameter that describes a noise created during the rotation of the rotor arrangement,
a temperature parameter that describes a temperature at a component of the rotation device, particularly at a non-rotatingly supported component of the rotation device,
an environmental parameter that describes the condition of a surrounding atmosphere, for example an environmental temperature, an atmospheric pressure in the environment, a humidity of the atmosphere in the environment, etc.,
a load parameter that describes a mechanical load on the rotor of the electric motor, for example a pressure created downstream in the fluid path of a created fluid flow.

For example, the vibration parameter can be detected by means of an acceleration sensor. For example, the noise parameter can be detected by means of a microphone. For example, the temperature parameter can be detected by means of a temperature sensor.

The load parameter can be detected, for example, by means of a pressure sensor downstream of the rotor arrangement, if the rotation device is a flow producing device. It can be determined alternatively or additionally by means of a torque sensor on the rotor arrangement. One of these sensors or multiple of these sensors can be part of the determination device.

Additionally or alternatively, the determination device can comprise additional sensors, for example a pressure sensor upstream of the rotor arrangement, in case of a configuration of the rotation device as flow producing device, one or more sensors that detect the atmosphere in the environment (atmospheric pressure, atmospheric temperature, atmospheric humidity, etc.). Additionally or alternatively, the determination device can also detect a current condition of one or more additional components of a system or a machine comprising the rotation device.

The method according to the present disclosure can be particularly carried out using any embodiment of the rotation device and particularly the flow producing device described above.

### BRIEF DESCRIPTION OF THE DRAWINGS

Advantageous embodiments of the present disclosure are derived from the dependent claims, the description and the drawing. In the following, preferred embodiments of the present disclosure are explained in detail based on the attached drawing. The drawing shows:

FIG. 1 a block diagram of an embodiment of a rotation device configured as flow producing device,

FIG. 2 a schematic principle illustration of a flow producer of the flow producing device of FIG. 1,

FIG. 3 a schematic basic illustration of the determination of a power-rotation-correlation that indicates the dependency of a power of the electric motor of the rotation device from a rotation of the rotor arrangement around a rotation axis,

FIG. 4 a schematic block-diagram-like illustration of an embodiment for evaluation of the determined power-rotation-correlation of FIG. 3 based on a coefficient comparison,

FIGS. 5 and 6 a flow diagram of an embodiment of a method according to the present disclosure respectively.

### DETAILED DESCRIPTION

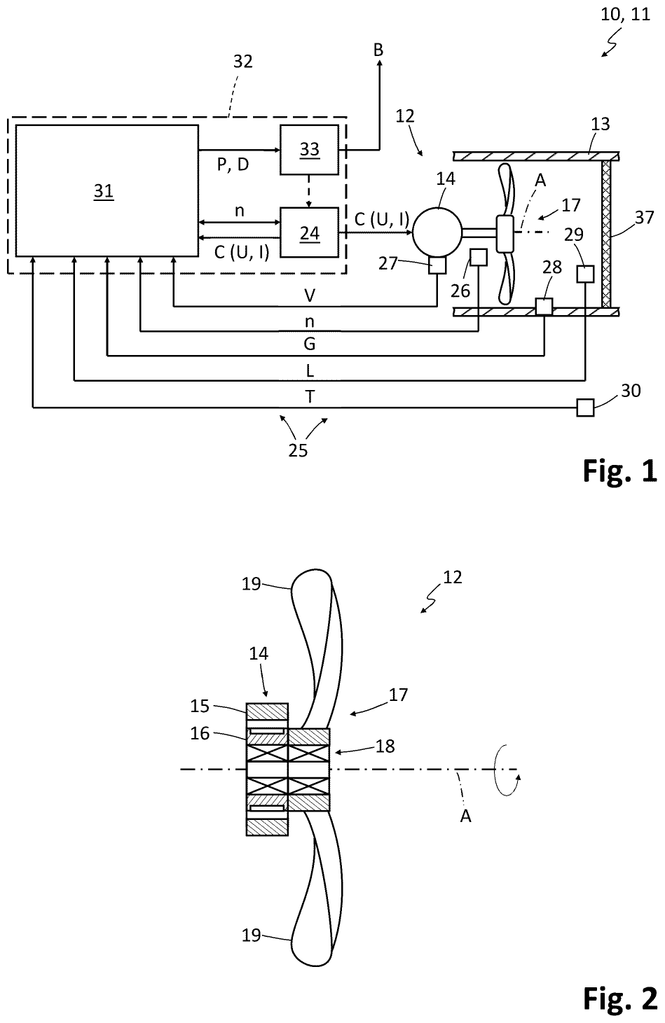

FIG. 1 shows a block diagram of an embodiment of a rotation device 10, which is configured as flow producing device 11 according to the example. The flow producing device 11 has at least one flow producer for producing a fluid flow. In the embodiment described here the flow producer is formed by a fan 12 for producing an airflow in a flow channel 13. The flow producing device 11 can comprise multiple flow producers and according to the example multiple fans 12.

Each flow producer (here: fan 12) has an electric motor 14 with a stator 15 and a rotor 16 (FIG. 2). The rotor 16 is part of a rotor arrangement 17 of the rotation device 10—according to the example of the flow producing device 11 or the at least one flow producer (here: fan 12). The rotor arrangement 17 is rotatingly supported about a rotation axis A by means of a bearing arrangement 18. In the embodiment the rotor arrangement 17 has an impeller and/or multiple fan blades 19 that are indirectly or directly connected with the rotor 16 of the electric motor 14 in a torque-proof manner. In case of rotation of the rotor arrangement 17 around the rotation axis A, the fan blades 19 of fan 12 create a gas flow, for example an air flow, inside flow channel 13. As an alternative to the illustrated embodiment the fan blades 19 can also be drivingly connected with rotor 16 of electric motor 14 in another manner. Preferably all of the components of the rotor arrangement 17 rotate around a common rotation axis A.

The electric motor can be a brushless direct current motor (BLDC) in the embodiment.

The bearing arrangement 18 comprises at least one rotation bearing that is configured as roller body bearing. Cylindrical bodies or balls can be used as roller bodies.

The electric motor 14 is controlled by means of a motor control 24. For this purpose, motor control 24 presets at least one motor control parameter C, for example a motor voltage U, and/or a motor current I. In the embodiment illustrated here the electric motor 14 is rotational speed controlled. The rotational speed n of rotor 16 of electric motor 14 and thus the rotational speed n of rotor arrangement 17 can be adjusted by means of a suitable motor control parameter C, for example by means of a stator magnetic field that rotates around the rotation axis A, which can be created by means of stator windings of stator 15 that are distributed around the rotation axis A. The motor control 24 can comprise a frequency converter for this purpose.

The rotation device 10 or flow producing device 11 comprises a determination device 25. The determination device 25 is configured to determine parameters that characterize the current operating condition of the rotation device 10 or the flow producing device 11 and, as an option, additionally a condition of the environment.

In the embodiment, determination device 25 comprises one or more sensors for this purpose. The number of sensors and the at least one measured parameter can vary depending on the embodiment. According to the example determination device 25 has a rotational speed sensor 26 for detection of a rotational speed of rotor 16 of the electric motor 14 that preferably corresponds with the rotational speed n of rotor arrangement 17. The rotational speed sensor 26 can be part of the electric motor 14 or also assigned to another component of rotor arrangement 17. Additionally or alternatively to the rotational speed sensor 26 also a rotational torque sensor can be used.

Instead of a physical rotational speed sensor 26 also a method for determination of the rotational speed realized as software can be used, for example an observer. The rotational speed sensor can thus be exclusively realized as a hardware component or as a software component or as a combination of a hardware and software component.

In modification to the illustrated embodiment instead of a torque-proof driving connection between rotor 16 and other components of rotor arrangement 17 (particularly impeller or fan blades 19) also a driving connection having a transmission and/or another coupling unit can be realized, for example if the driving connection shall provide a different transmission ratio than 1:1 and/or if the rotation axis of rotor 17 and the rotation axis of other components of rotor arrangement 17 shall not be arranged along a common straight line.

For detection of vibrations or oscillations in the form of a vibration parameter V an acceleration sensor 27 or another suitable oscillation sensor is provided. According to the example, acceleration sensor 27 is assigned to a non-rotatingly supported component of fan 12. By means of a sound sensor, for example a microphone 28, a noise parameter G is detected that characterizes the noise during a rotation of rotor arrangement 17 around rotation axis A, for example the comprised frequencies and/or noise level.

By means of a pressure sensor 29 a gas pressure or air pressure downstream of fan 12 inside flow channel 13 is detected, that forms a load parameter L in the embodiment. Additionally or alternatively, also the pressure upstream of fan 12 can be detected.

According to the example at least one environmental sensor is additionally provided, that is here, by way of example, configured as a temperature sensor 30 for detection of a temperature parameter T of the surrounding atmosphere. Additionally or alternatively to temperature sensor 30, also a humidity sensor for detection of the humidity of the surrounding atmosphere or a pressure sensor for detection of the pressure of the surrounding atmosphere outside flow channel 13 can be provided.

In general, the number and the type of provided sensors can be changed depending on the application.

Additionally or alternatively to the at least one sensor, determination device 25 can comprise a computing unit 31, for example a microprocessor. By means of the computing unit 31 the determination device 25 can determine one or more parameters by way of computing. The computing device 31 is preferably communicatively connected with the motor control 24 or the computing unit 31 and the motor control 24 form part of a common computing device 32 as schematically illustrated in FIG. 1 by dashed lines.

In the embodiment illustrated in FIG. 1, sensors 26 to 30 of determination device 25 are communicatively connected with computing unit 31 of determination device 25. Alternatively or additionally, at least one of the sensors 26 to 30, for example the rotational speed sensor 26, can be directly communicatively connected with motor control 24. A sensor signal required in motor control 24 can thus be forwarded directly or indirectly, via computing unit 31, to motor control 24.

The determination device 25 is configured to determine at least one current rotation parameter D and at least one current power parameter P. The current rotation parameter D describes a current rotation movement of rotor arrangement 17 or of rotor 16 around rotation axis A, such as the rotational speed n and/or an angular velocity. In the illustrated embodiment rotational speed n is used as rotation parameter D.

The current power parameter P describes a current power of electric motor 14, for example an electric power. For example, the power can be determined by means of the set motor voltage U and/or the set motor current I. Additionally or alternatively, also the rotational torque M of electric motor 14 can be used as power parameter P. Motor control parameters C, such as the motor voltage U and/or the motor current I, provided in the motor control 24 can be provided to determination device 25 for determination of the at least one power parameter P.

In general, any parameter of the following parameters or multiple parameters of the following parameters can be used in arbitrary combination as rotation parameter D:
the rotational speed n,
the angular velocity of rotor arrangement 17,
a counter voltage or electromagnetic force (EMF) induced due to the rotation of rotor 16 in the stator windings of stator 17,
a circulation speed or a frequency or another suitable parameter for describing the spatially varying stator magnetic field of stator 17 around rotation axis A (stator rotating field),
any motor control parameter C set by motor control 24 for rotation control of rotor 16.

As explained, any of the following parameters or an arbitrary combination of the following indicated parameters can be used as power parameter P:
the motor voltage U of electric motor 14,
the motor current I of electric motor 14,
the electric power of electric motor 14,
the rotational torque M or another parameter describing the electrical or mechanical power of the electric motor 14,
any motor control parameter C of motor control 24 that is used for setting the power of the electric motor 14, such as a duty cycle of the motor current I and/or the motor voltage U.

The at least one power parameter P and the at least one rotation parameter D can be determined by means of sensors, by computing, by means of an observer or in another suitable manner using determination device 25.

The rotation device 10 and according to the example the flow producing device 11 has in addition an evaluation device 33 that can be part of the computing device 32 together with motor control 24 and/or computing unit 31. The evaluation device 33 is alternatively separately configured and communicatively connected at least with determination device 25 and alternatively additionally with motor control 24. Particularly the evaluation device 33 and—if present—the computing unit 31 of determination device 25 form a common unit. A determination of a parameter and the evaluation of the at least one parameter by computing can be functionally integrated in a common method progress.

The evaluation device 33 is configured to determine a condition parameter B using the at least one current power parameter P and the at least one current rotation parameter D, wherein the condition parameter B characterizes the condition of the bearing arrangement 18. For this purpose, according to the example, a relation or correlation between the current power of the electric motor 14 described by the at least one power parameter P and the current rotation of rotor arrangement 17 described by the at least one rotation parameter D is created.

The power of the electric motor 14 that is required for producing a specific rotation or rotation change depends, amongst others, from the condition of bearing arrangement 18. Particularly, for determination of the bearing condition during a determination time phase Δt (can be denoted as test condition of the rotation device 10) a determination of the at least one current power parameter P and the at least one current rotation parameter D for testing the bearing condition of bearing arrangement 18 is carried out. Within the determination time phase Δt, thereby, preferably a temporarily non-stationary operation of electric motor 14 is initiated, for example in that the rotation and/or the power provided to the electric motor 14 is varied or are varied. For example, the power provided to the electric motor 14 can be known or preset and the resulting rotational speed n can be determined during the determination time phase Δt—or the rotational speed n can be known or preset and the consumed or created power of the electric motor 14 can be determined during the determination time phase Δt. For example, thereby, the following test conditions of rotation device 10 can be used during the determination time phase Δt:
1) During the determination time phase Δt the electrical power can be increased or decreased and the change of the rotation resulting therefrom can be determined.
2) During the determination time phase Δt at least one rotational speed change (increase and/or decrease—for example from an initial rotational speed to a target rotational speed) can be preset and the power change required for this can be determined.
3) A duration for changing a rotation (for example increase or decrease of the rotational speed) with known or preset power can be determined and evaluated.

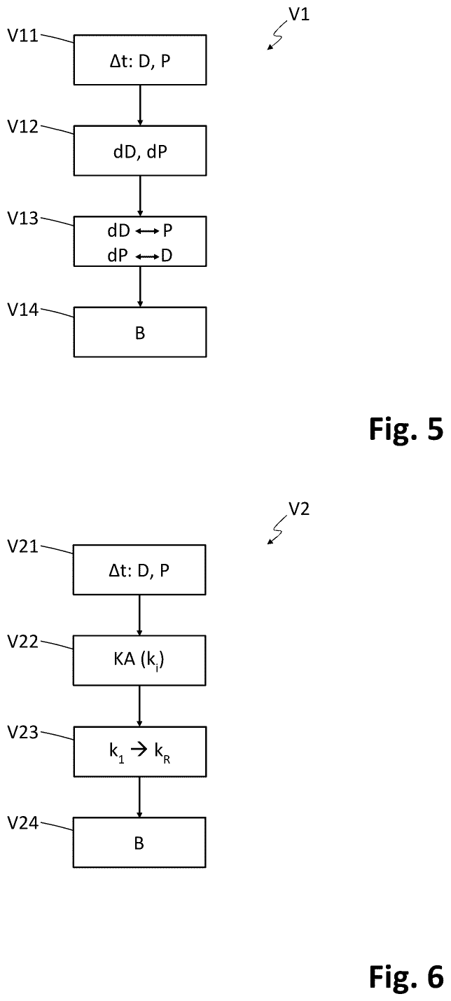

By way of example, for this purpose, a first embodiment of a method according to the present disclosure is illustrated in FIG. 5 that is denoted as first method V1. In a first method step V11 of this first method V1 the at least one rotation parameter D and the at least one power parameter P are determined by means of the determination device 25 during the determination time phase Δt. During the determination time phase Δt (i) the temporarily changing rotation is determined that results from a known (constant or temporarily changing) power and/or (ii) the temporarily changing power is determined resulting from a known (constant or temporarily changing) rotation. As explained the current power of the electric motor 14 is indicated by means of the at least one power parameter P and the current rotation of the rotor arrangement 17 is indicated by means of the at least one rotation parameter D in the determination time phase Δt.

In a second method step V12 of first method V1, according to the example, a pre-processing of the values obtained during the determination time phase Δt for the at least one rotation parameter D and the at least one power parameter P is carried out. Thereby a temporal change dD of the rotation and/or a temporal change dP of the power of the electric motor 14 can be determined. Subsequently the determined parameters D, P and/or the temporal changes dD, dP thereof are evaluated in a third method step V13 of first method V1 in that a relation between the respectively preset parameter D, P and the parameter P or D resulting therefrom is determined as explained above. Finally, in a fourth method step V14 of first method V1, based thereon the condition parameter B can be determined describing the condition of bearing arrangement 18.

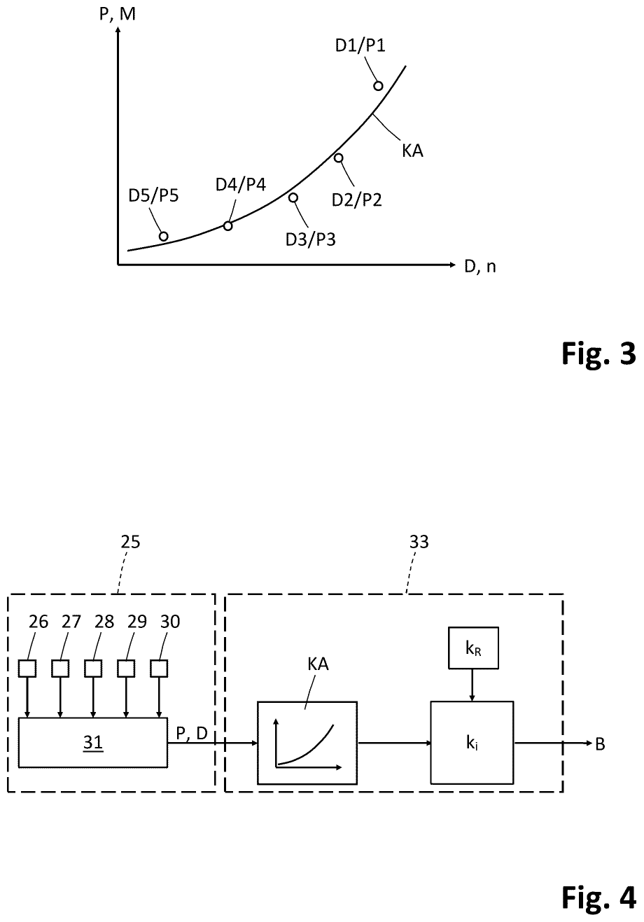

Based on FIGS. 3, 4 and 6 in the following another embodiment of the method (denoted as second method V2 in the following) is explained in order to determine the condition of bearing arrangement 18 or the bearing condition parameter B.

First, during the determination time phase Δt at multiple subsequent points in time a rotation parameter D and an assigned power parameter P are determined in each case (first method step V21 of second method V2 in FIG. 6). From the individual parameter values a power-rotation-correlation KA is determined by means of calculation and/or approximation, as exemplarily illustrated in FIG. 3 (second method step V22 of second method V2 in FIG. 6). For example, thereby, the power parameter P can be determined depending on a rotation parameter D according to the following polynomial function of degree n:

$$P = {k}_{0} + {k}_{1} \cdot D + {k}_{2} \cdot {D}^{2} + … + {k}_{n} \cdot {D}^{n} \qquad ( 1 )$$

The polynomial function according to equation (1) comprises the current coefficients kᵢ that can be determined depending on the determined values for the power parameter P and the rotation parameter D. Depending on the degree n of the polynomial function measurements or determinations for the rotation parameter D and the power parameter P during the determination time phase Δt have to be carried out in a corresponding number.

By means of approximation (for example “polynomial fitting”) than the current power-rotation-correlation KA can be determined. For this purpose, any known approximation methods can be used, such as the method of least squares or similar.

Preferably the determined polynomial function or the determined current power-rotation-correlation KA has at least the degree 2 (that means n≥2). A function of second degree (n=2) is sufficient.

As schematically illustrated in FIG. 4, at least one of the determined coefficients kᵢ is compared with a reference coefficient k_{R} (third method step V23 of second method V2 in FIG. 6). During this comparison also two or more than two reference coefficients k_{Rm} (m=1 bis max) having different amounts can be used: k_{R1}<k_{R2}<k_{R3}< . . . <k_{Rmax2}. One single reference coefficient k_{R} is sufficient in the simplest case and thus forms a threshold in order to distinguish a fault-free bearing arrangement 18 from an incorrectly supporting support arrangement 18 that, for example, comprises an unacceptable wear condition, an insufficient lubrication or a damage.

Particularly, in third method step V23 of this second method V2 the coefficient k₁ for comparison with the at least one reference coefficient k_{R} is used, which describes a linear relation between the power parameter P and the rotation parameter D. For example, here, a linear correlation between the rotational torque M as power parameter P and the rotational speed n as rotation parameter D can be evaluated. Depending on whether or not the coefficient k₁ describing the linear component of the polynomial function exceeds the reference coefficient k_{R}, it results a bearing condition parameter B that distinguishes a correctly functioning bearing arrangement from an incorrectly functioning bearing arrangement 18 and can thus take two conditions (fourth method step V24 of second method V2).

If multiple reference coefficients k_{Rm} (m≥2) are used, then the bearing condition parameter B can take more than two different conditions respectively and can distinguish, for example: (1) correctly functioning bearing arrangement, (2) the bearing arrangement has need for service, (3) defective bearing arrangement, etc.

The rotation device 10 or the flow producing device 11 and particularly the evaluation device 33 can transmit the determined condition parameter B of bearing arrangement 18 via a suitable operation interface for an operator or a superordinate or external device, such as a central server or a cloud.

Additionally or alternatively to the variants described above, it is also possible that for the determination of the condition parameter B of bearing arrangement 18 methods and/or devices of machine learning and/or artificial intelligence (AI) are used. For example, the determination of the relation between the rotation or a rotation change and the power or a power change of electric motor 14 can be evaluated using methods and devices of artificial intelligence and/or of machine learning and based thereon the condition parameter B can be determined. In such a procedure it can be learned in the evaluation device 33 by training data and/or during operation of rotation device 10 in which case the bearing arrangement 18 has a correct condition or incorrect condition. Also here, a relation between the rotation or rotation change with the power or power change of electric motor 14 is determined and therefrom the condition of the at least one bearing of bearing arrangement 18 is concluded. For example, for this purpose artificial neural networks, semantic networks, frames, predicate logic or support vector machines (SVM) or other known devices can be used. The machine learning can be supervised learning, non-supervised learning or reinforcement learning. Methods for pattern recognition, pattern analysis or pattern prediction can be used in the context of machine learning.

In the context of the evaluation of the at least one rotation parameter D and/or the at least one power parameter P by evaluation device 33, in all embodiments, optionally, also additional parameters can be considered, for example at least one load parameter describing the load condition of rotor 16 of the electric motor 14 and/or at least one environmental parameter of the surrounding atmosphere and/or at least one noise parameter during operation of the rotation device 10 and/or a vibration parameter during operation of the rotation device 10.

The electrical power necessary for achieving a specific rotation of rotor 16 also depends on the load or the work that the rotor arrangement 17 and according to the example the fan blades 19 have to provide for producing the gas flow. For example, inside flow channel 13 due to installed components, for example a filter 37, an increasing counter pressure can develop, that may vary depending on the condition of the flow channel 13. The filter 37 can clog with increasing operation duration and thus can increase the flow resistance. Also, switchable or adjustable flaps, valves or the like that are present in the flow channel 13 can modify the load on rotor 16. For this reason, as an option, the at least one load parameter L (according to the example the pressure inside the flow channel 13 downstream of fan 12) can be considered. Depending on the application the load parameter L can also indicate positions of valves, flow passage openings, flaps or the like.

Environmental influences, such as temperature, humidity or the like can influence the rotation device and particularly the electric motor 14, for example the electrical resistance in the stator windings. Such influences can be considered by means of a temperature parameter T. It is additionally or alternatively possible that the temperature parameter T describes the temperature directly on the electric motor 14 or on stator 15 (for example temperature sensor on or in electric motor 14).

Taking into account vibrations (vibration parameter V) and/or noise (noise parameter G) can further improve the accuracy of the evaluation, for example in order to detect external influences or damages outside of bearing arrangement 18 and to be able to distinguish them from an incorrect bearing. For example, a noise measurement in the area of the flow channel 13 can indicate a damage on a rotating component of rotor arrangement 17 (for example fan blades 19) or a scraping contact of a rotating part of rotor arrangement 17 with a surrounding part of the system (for example flow channel 13). By means of the vibration parameter V an additional parameter can be provided, for example, in order to be able to better distinguish an incorrect bearing due to the bearing arrangement 18 from an external influence.

The determination device 25 and the evaluation device 33 are part of the computing device 32 in the embodiment. Alternatively to this, the computing unit 31 and/or the evaluation device 33 could also be provided by means of a communicatively coupled central server or by means of an internet service (Cloud service).

In any embodiment described above the evaluation device 33 can also be configured to evaluate the at least one rotation parameter in the frequency domain. For this purpose, the at least one rotation parameter D can be transformed into the frequency domain by means of a Fourier transformation (particularly FFT) and can there be evaluated with regard to its components (value of the frequency and/or absolute value of the frequency component). Thereby, preferably, the counter voltage or electromagnetic force (EMF) created in the stator windings of stator 17 due to rotation of rotor 16 can be used as rotation parameter D. Also an analysis of harmonics and/or wavelets (for example in the context of a wavelet transformation) or similar can be used.

The present disclosure refers to a rotation device 10, particularly a flow producing device 11, as well as methods V1, V2 that are configured to determine a condition of a bearing arrangement 18 of rotation device 10. The bearing arrangement 18 bears a rotor 16 of an electric motor 14 and/or a rotor arrangement 17 comprising the rotor rotatingly around a rotating axis A. At least one rotation parameter D is determined that describes the rotation around rotation axis A, as well as at least one power parameter that describes the power of the electric motor. The determination of the at least one rotation parameter D and the at least one power parameter P is carried out to a current observation point in time, particularly at least at one observation point in time during a determination time phase Δt. The at least one rotation parameter D and the at least one power parameter P are evaluated in relation to one another and therefrom a condition parameter B is determined describing the condition of bearing arrangement 18. Particularly for this purpose a linear component of a power-rotation-correlation KA between the at least one current rotation parameter D and the at least one current power parameter P is used.

### LIST OF REFERENCE SIGNS

10 rotation device
11 flow producing device
12 fan
13 flow channel
14 electric motor
15 stator
16 rotor
17 rotor arrangement
18 bearing arrangement
19 fan blade
24 motor control
25 determination device
26 rotational speed sensor
27 acceleration sensor
28 microphone
29 pressure sensor
30 temperature sensor
31 computing unit
32 computing device
33 evaluation device
37 filter
Δt determination time phase
A rotation axis
B condition parameter of bearing arrangement
C motor control parameter
D rotation parameter
dD temporal change of rotation parameter
dP temporal change of power parameter
G noise parameter
I motor current
KA current power-rotation-correlation
k₁ coefficient of current power-rotation-correlation (i=0, 1, 2, . . . , n)
k_{R} reference coefficient
L load parameter
M torque
n rotational speed
P power parameter
T temperature parameter
U motor voltage
V vibration parameter
V1 first method
V11 first method step of first method
V12 second method step of first method
V13 third method step of first method
V14 fourth method step of first method
V2 second method
V21 first method step of second method
V22 second method step of second method
V23 third method step of second method
V24 fourth method step of second method

1. A rotation device, particularly flow producing device, comprising:
an electric motor having a stator and a rotor,
a rotor arrangement comprising the rotor and being rotatingly supported around a rotation axis by means of a bearing arrangement,
a determination device configured to determine at least one rotation parameter describing a current rotation of the rotor arrangement and at least one power parameter describing a current power of the electric motor,
an evaluation device that is configured to evaluate the at least one rotation parameter and the at least one power parameter in relation to one another and to determine therefrom a condition of the bearing arrangement, wherein the evaluation device is further configured to determine and evaluate at least one current power-rotation-correlation for the evaluation of the at least one rotation parameter and the at least one power parameter in relation to one another, which corresponds to a polynomial of at least second degree.

2. The rotation device according to claim 1, wherein the at least one current power-rotation-correlation comprises linear and nonlinear components.

3. The rotation device according to claim 2, wherein the at least one current power-rotation-correlation indicates a linear coefficient of a linear component between rotation of the rotation arrangement and power of the electric motor and which describes a condition of the bearing arrangement.

4. The rotation device according to claim 2, wherein the at least one current power-rotation-correlation is a mathematical function.

5. The rotation device according to claim 1, wherein the evaluation device is configured to determine and evaluate the power consumption of the electric motor based on the at least one power parameter at a predefined rotation of rotor arrangement.

6. The rotation device according to claim 1, wherein the evaluation device is configured to determine and evaluate rotation of the rotor arrangement based on the at least one rotation parameter at a predefined power consumption of the electric motor.

7. The rotation device according to claim 1, wherein the evaluation device is configured to evaluate a time duration required to achieve a predefined rotational speed change at a predefined power consumption of the electric motor.

8. The rotation device according to claim 5, wherein a predefined rotation of the electric motor is a constant rotational speed or wherein a predefined power consumption of the electric motor is a constant power consumption.

9. The rotation device according to claim 1, further comprising a motor control that is electrically connected with the electric motor, for open-loop control and/or closed-loop control.

10. The rotation device according to claim 9, wherein the motor control and the evaluation device are realized in a common computing device.

11. The rotation device according to claim 1, wherein the determination device is configured to determine at least one of the parameters indicated in the following as rotation parameter:
a rotational speed of the rotor arrangement,
an angular velocity of the rotor arrangement,
an electromagnetic force and/or voltage induced in a stator winding of the stator of the electric motor due to rotation of the rotor of the electric motor,
a magnetic field parameter describing a temporal and/or spatial change of a stator magnetic field of the stator,
a motor control parameter used for rotation control of the rotor of the electric motor.

12. The rotation device according to claim 1, wherein the determination device is configured to determine in addition to the at least one power parameter and in addition to the at least one rotation parameter at least one of the parameters indicated in the following:
a vibration parameter that describes a vibration on a non-rotatingly supported component of the rotation device,
a noise parameter that describes a noise created during rotation of the rotor arrangement,
a temperature parameter that describes a temperature on a component of the rotation device,
a load parameter that describes a mechanical load on the rotor of the electric motor.

13. The rotation device according to claim 1, wherein the determination device is configured to determine at least one of the parameters indicated in the following as power parameters:
a motor voltage of the electric motor,
a motor current of the electric motor,
an electrical power of the electric motor,
a rotational torque of the electric motor,
a motor control parameter used for power control of the electric motor.

14. A method for determination of a condition of a bearing arrangement of a rotation device, particularly a flow producing device, having an electric motor comprising a stator and a rotor, having a rotor arrangement comprising the rotor that is rotatingly supported around a rotation axis by means of the bearing arrangement, wherein the method comprises:
determining at least one rotation parameter describing a current rotation of the rotor arrangement and at least one power parameter describing a current power of the electric motor,
evaluating the at least one rotation parameter and the at least one power parameter in relation to one another, wherein therefrom the condition of the bearing arrangement is determined.

15. The rotation device according to claim 9, wherein the motor control is electrically connected with the stator for open-loop control and/or closed-loop control.

16. The rotation device according to claim 3, wherein the wherein the at least one current power-rotation-correlation is a mathematical function.

17. The rotation device according to claim 16, wherein the evaluation device is configured to determine and evaluate the power consumption of the electric motor based on the at least one power parameter at a predefined rotation of rotor arrangement.

18. The rotation device according to claim 17, wherein the wherein the evaluation device is configured to determine and evaluate rotation of the rotor arrangement based on the at least one rotation parameter at a predefined power consumption of the electric motor.

19. The rotation device according to claim 18, wherein the evaluation device is configured to evaluate a time duration required to achieve a predefined rotational speed change at a predefined power consumption of the electric motor.

20. The rotation device according to claim 19, wherein a predefined rotation of the electric motor is a constant rotational speed or wherein a predefined power consumption of the electric motor is a constant power consumption.
